(19) United States
(12) Patent Application Publication
(10) Pub. No.: US 2026/0278904 A1
(43) Pub. Date: Sep. 17, 2026

(54) Process that uses an NLE (non-linear editor) workflow and combines it with generative video and audio processes into a streamlined NLE using node-based visual sequencing to integrate generative features directly in the editor.

(71) Applicants: Andrei Nikolas Shulgach, Owings Mills, MD (US); Dmitrii Miachin, Georgetown, TX (US)

(72) Inventors: Andrei Nikolas Shulgach, Owings Mills, MD (US); Dmitrii Miachin, Georgetown, TX (US)

(21) Appl. No.: 19/078,727

(22) Filed: Mar. 13, 2025

(51) Int. Cl. G06T 13/80; G06F 40/205; G06F 40/247; G06T 3/40; G06T 5/60; G06T 7/11; G06T 13/40

(52) U.S. Cl. CPC G06T 13/80; G06F 40/205; G06F 40/247; G06T 3/40; G06T 5/60; G06T 7/11; G06T 13/40; G06T 2207/10016; G06T 2207/20016; G06T 2210/36

(57) ABSTRACT

An integrated node-based non-linear editing system is disclosed that streamlines video production by incorporating generative video and audio processing directly within the editing interface. The system enables users to upload or create source files such as text-based scripts or visual documents which are analyzed using artificial intelligence models to identify segments that are automatically mapped to clip nodes. Each node represents a media clip, a generative transformation, or an effect modifier, thereby facilitating features such as visual style transfer, character replacement, object replacement, face-swapping, lip synchronization, and environmental adjustments. The system further supports automated clip matching from a large-scale database and provides advanced post-processing functions including AI-driven upscaling and color correction. This unified platform eliminates the need for external plug-ins, enabling efficient, AI-first video production for applications in film, television, advertising, and live event production.

### CROSS-REFERENCE TO RELATED APPLICATIONS

This application claims the benefit of U.S. Provisional Patent Application No. 63/566,376, filed on Mar. 17, 2024, the entirety of which is incorporated by reference herein.

### PRIOR ART

The inventors, Andrei Nikolas Shulgach and Dmitrii Miachin, are not presently aware of any prior art references that specifically teach or suggest the claimed invention.

### BACKGROUND OF THE INVENTION

### Field of the Invention

The present invention relates generally to digital media production and non-linear editing (NLE) workflows, and more particularly to a node-based editing system that integrates generative video and audio processes (e.g., using stable diffusion, Sora, Runway) and a large-scale clip database for more efficient content creation and editing.

### Description of Related Art

Traditional non-linear editing software typically relies on timeline-based interfaces to arrange and modify video or audio clips. While a few modern platforms have begun integrating basic generative capabilities such as AI-driven style transfers or automated audio enhancements, these implementations often remain limited in scope and restrict users to a conventional timeline approach. As a result, content creators are unable to apply a broad range of real-time generative transformations or easily experiment with multiple variations. The overall workflow is fragmented, requiring external plug-ins or additional software to achieve more advanced, flexible generative editing. Consequently, users seeking a comprehensive system that merges robust generative tools with a more dynamic (e.g., node-based) workflow still face significant challenges.

In addition, node-based editing platforms are sometimes available for specialized visual effects or compositing tasks; however, they are not generally designed to incorporate generative processes (e.g., such as stable diffusion, Sora, Runway) directly within the main editing interface. As a result, content creators who want to seamlessly integrate AI-generated video or audio with traditional editing features must juggle multiple tools, re-importing and re-exporting clips at various stages.

Another challenge in current systems is the lack of automated clip selection from large databases. Editors may manually search external libraries for suitable footage or rely on limited metadata tagging. Existing solutions rarely integrate a text-based or script-based approach to clip matching, where lines of dialogue or scene descriptions can be mapped automatically to relevant video assets.

Consequently, there is a need for a unified NLE that merges a node-based visual workflow with advanced generative features and an extensive clip database. Such a system would allow creators to directly reference scripts, automatically populate a sequence with relevant clips, and apply generative transformations from various generative models in real time, and fine-tune edits using standard NLE tools like trimming, transitions, color correction, and audio clip splicing. This streamlined approach aims to eliminate the inefficiencies of switching between multiple applications and create an innovative and creative editing process designed with AI-first.

### SUMMARY OF THE INVENTION

Traditional non-linear editing (NLE) software typically relies on timeline-based interfaces to arrange and modify video or audio clips. While a few modern platforms have begun integrating basic generative features, such as AI-driven style transfers or automated audio enhancements, these implementations often remain limited and rigid, requiring reliance on external plug-ins or separate applications for more advanced transformations. Although generative models like Stable Diffusion, Sora, and Runway exist, they are generally not embedded within the main editing environment, forcing editors to switch between multiple tools and workflows. This fragmentation makes it difficult to incorporate new or updated AI capabilities, for instance, a more advanced face-swapping or lip-syncing algorithm, without extensive reconfiguration or custom plug-in development. By contrast, a node-based approach offers a flexible framework in which each AI tool can be introduced as a new node within the editing pipeline. As novel models become available, the user can simply update the software and select the new node, seamlessly integrating cutting-edge capabilities, such as performing face-swapping and lip-syncing in a single pass, without leaving the core NLE. This versatility reduces workflow disruption and allows editors to rapidly adopt and experiment with different generative technologies as they evolve.

### BRIEF DESCRIPTION OF DRAWINGS

FIG. 1 is a sample user interface screenshot of the node-based editor, illustrating how clip nodes connect to form a sequential workflow. This figure also highlights various generative adjustment options beneath each clip thumbnail, including a brief summary of the contents of the clip, actor profile selection, camera motion, saved visual style profiles, and VFX layer configurations. For demonstration purposes, the clip thumbnails are blurred; in an actual implementation, these would display real media.

FIG. 2 is a sample user interface screenshot illustrating the clip database search functionality, which dynamically loads clips based on user-entered search terms and allows them to be swapped directly into the highlighted node. For demonstration purposes, the clip thumbnails are blurred; in an actual implementation, these would display real media.

FIG. 3 is a sample user interface screenshot illustrating the modification of a clip node via an additional environmental modifier node. In this example, the modifier node provides control over the clip's environmental parameters including lighting, background, and optionally volumetric visual effects.

### DETAILED DESCRIPTION OF THE INVENTION

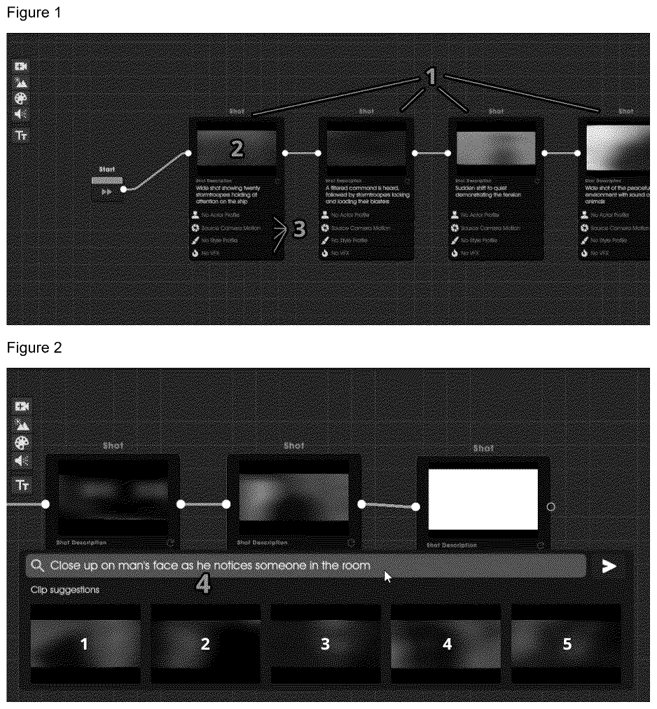

The present invention provides a node-based non-linear editing (NLE) system that seamlessly integrates generative video and audio processes (e.g., Stable Diffusion, Sora, Runway) and a large-scale clip database, enabling users to import, modify, and export media content in a unified environment. In contrast to conventional timeline-only editing solutions, the invention leverages a modular, node-based workflow in which each node can represent a media clip, a generative tool, or an effect modifier, thereby allowing for more flexible and extensible editing. Referring generally to FIGS. 1-3, the following paragraphs detail how each component works together to provide an AI-first editing process.

### System Overview

In one embodiment, the system consists of a front-end user interface (UI), a back-end AI processing layer, and an online storage component for large-scale clip management. A dynamic DNS service may be used to facilitate secure connections and port forwarding (e.g., #1 from the provisional), ensuring that users can remotely access the back-end software. The online storage (#2) holds a vast library of video clips, potentially tens of thousands, that the system can automatically match to user-provided script lines, storyboards, or other source materials.

As shown in FIG. 1, the node-based editor displays interconnected clip nodes arranged in a sequential workflow (1). Each node typically includes a thumbnail (or preview) of the assigned clip (2), along with generative adjustment options such as actor profile selection, camera motion, visual style profiles, or VFX layers (3). The user can rearrange nodes, connect or disconnect them, and apply different effects without leaving the main interface.

### Uploading and Analyzing Source Files

In one embodiment, users may begin by uploading a source file, such as a text-based script, storyboard, or dialogue document, to initiate the editing process. In an alternative embodiment, the system includes an integrated script editor that enables users to create or modify a script directly within the software. Once a file (or script) is provided, the system analyzes its contents to identify relevant segments. For text-based documents, a large language model (LLM) such as ChatGPT, GPT-4, or similar tools can parse and index lines of dialogue or descriptive text. For visual content (e.g., storyboards, comic panels, images), a segmentation model (e.g., SAM 2, YOLO, Mask R-CNN) can isolate frames or objects. Each identified segment is then mapped to a corresponding clip or generative process. Specifically, for text documents, a synonym-based matching algorithm or advanced LLM (e.g., OpenAI API) may parse each line (#15/#16 from the provisional) and compare it against the metadata and tags of clips stored in the online database. When a match is found, the system automatically populates the node-based editor with the selected clip, thereby creating a new node in the sequence.

In cases where the uploaded file is visual, the system can analyze frames or objects (using a segmentation mode), then create corresponding nodes. For instance, a comic book with multiple panels might be converted into a sequence of nodes, each representing a panel or scene. If a user prefers to use custom footage instead of the existing database, they can import files directly into the node editor (#4 in the provisional), where each file becomes its own node. These imported clips can then be modified, replaced, or rearranged like any other node in the system.

### Generative Modifications and Effects

Referring to FIG. 2, users can search the clip database in real time to swap existing clips with alternative options. The search functionality automatically populates results based on user-entered keywords or script lines (4). Once a desired clip is located, the user can replace the node's existing clip with the new option, instantly updating the sequence.

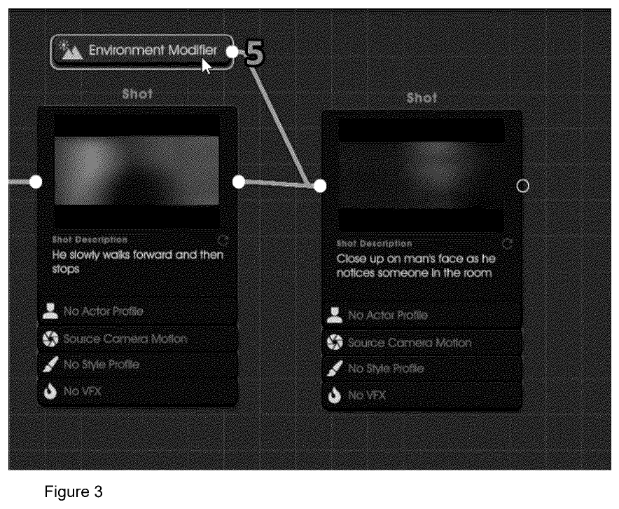

FIG. 3 illustrates how an environmental modifier node (5) may be added to any clip node to adjust parameters such as lighting, background, or volumetric visual effects. Beyond these environmental adjustments, each clip node can also be sent to Stable Diffusion or a similar generative model (#10/#11/#17 in the provisional) for AI-driven transformations, for example, changing the overall visual style, replacing a character's appearance, or applying advanced face-swapping with lip-syncing (#18 in the provisional). Because the system is node-based, newly released or updated AI models (e.g., an improved face-swapping algorithm) can be integrated simply by adding a new node type, preserving the user's existing workflow.

In addition to visual modifications, the system can perform audio transformations. For instance, a character's dialogue can be replaced with a previously uploaded voice profile, matching the script lines or text-based prompts (#20 in the provisional). To ensure that the character's mouth movements align with the replaced audio, the invention can incorporate generative lip-sync models, for example, Wav2Lip, LipGAN, or SyncNet, which analyze and retarget mouth movements in real time. By integrating these models as individual nodes within the editor, the system can achieve natural-looking lip synchronization without requiring manual keyframing or external tools.

### Editing Workflow and Timeline Functions

Although the primary interface is node-based, the invention can optionally include a timeline view (#3/#5/#6 in the provisional) for users who prefer a more traditional NLE approach for playback viewing. Clips arranged in the timeline are still reflective of their respective nodes in the current connected sequence of nodes. If a user disconnects a node and changes the sequence of nodes, the timeline will instantly update to reflect the changes. Transitions (e.g., fades, wipes) and overlays can be applied via node-based connections.

The node-based framework further integrates color correction and grading (#9 in the provisional), enabling users to apply and stack color profiles as modifiers at both the individual clip level and across groups of nodes or entire project settings. In one embodiment, color profiles are automatically matched to clips by referencing key frames, while in an alternative embodiment, users may manually adjust color parameters. In this system, all clip adjustments, including color correction, grading, and other generative transformations, are implemented as node modifiers, supporting the unified editing workflow.

The system can automatically upscale or reformat clips for different output requirements (e.g., 4K, 16:9, or vertical formats). Each node in the editor retains its own set of parameters, enabling advanced branching workflows (#22 in the provisional) where multiple versions of a sequence can coexist without overwriting one another.

### Export and Final Output

Once a user is satisfied with the edited project, they can export the entire sequence (#12/#13 in the provisional) in a variety of industry-standard video formats, such as MP4, MOV, AVI, MKV, or other standard formats, tailored to diverse applications including cinema projection, streaming platforms (e.g., Netflix, YouTube, Amazon Prime), and broadcast television. The system provides comprehensive render settings that allow the user to adjust parameters such as resolution (ranging from HD to 4K or 8K), aspect ratio (e.g., 16:9, 4:3, 2.39:1), frame rate (e.g., 24, 30, 60 fps), and color depth. In addition, the platform integrates advanced post-processing modules, including AI-driven upscaling models (such as ESRGAN or Real-ESRGAN) to improve image quality. By consolidating the editing, generative, and finishing processes within a single, unified platform, the invention streamlines production workflows, eliminates the need for external rendering or upscaling tools, and minimizes manual re-import/export cycles.

### Example Use Cases

This invention can be adapted for a wide range of creative industries, including:
Film & TV Production: Filmmakers can use AI-enhanced previsualization to generate animatics and virtual sets from text or minimal footage, enabling rapid scene prototyping. Additionally, deepfake dubbing, face-swapping, and automated editing nodes facilitate real-time VFX integration and creative post-production.
Advertising & Marketing: Brands can leverage a node-based generative system to automatically produce dynamic commercials and personalized video ads using text-to-video synthesis and real-time personalization. This enables rapid creative iteration across platforms, from streaming services to social media, while reducing production costs.
News & Journalism: News outlets can employ AI-driven nodes to generate concise video summaries complete with synthesized visuals and voiceovers from text or raw footage. Moreover, automated video report generation and synthetic newscasters enable real-time, multilingual broadcasts with minimal human intervention.
Corporate & Training Videos: Companies can produce high-quality training and corporate communications videos by converting text and slide decks into dynamic content featuring realistic AI avatars and graphics. The system supports on-demand customization, allowing personalized video versions tailored to different audiences.
Education & Online Courses: Educators can create engaging lecture videos where AI avatars deliver content alongside dynamically generated visuals and animations. This method allows for rapid production of multilingual, easily updated educational material that caters to diverse learning styles.
Music Videos & Concert Visuals: Music video creators can integrate AI nodes to generate stylistic visuals, such as automated B-roll, real-time animations, and deepfake avatars that synchronize with a song's rhythm and mood. In live concerts, these tools enable generative overlays and dynamic effects that enhance the overall performance and audience engagement.
Documentary Filmmaking: Documentarians can leverage AI upscaling, colorization, and frame interpolation nodes to restore and enhance archival footage into high-definition outputs. Additionally, AI-driven generative reconstruction and automated B-roll insertion enable the synthesis of missing scenes and streamline the editing process.

1. A method of editing video content using a node-based non-linear editor that integrates generative processes, the method comprising:
(a) receiving an input file selected from text-based scripts and visual documents;
(b) analyzing the input file to identify segments, wherein text segments are parsed by a large language model and visual segments are detected by a segmentation model;
(c) automatically mapping each identified segment to a respective clip node within the node-based editor;
(d) applying at least one generative transformation to at least one of the clip nodes using an artificial intelligence model; and
(e) exporting a final edited sequence from the node-based editor as a video file in an industry-standard format.

2. The method of claim 1, wherein the artificial intelligence model comprises at least one of Stable Diffusion, Sora, or Runway, and is configured to perform visual style transfers, character replacement, object replacement, environment adjustments, or face-swapping in real time.

3. The method of claim 1, further comprising comparing each text segment to metadata and tags of a clip database using a synonym-based matching algorithm or large language model, and automatically populating the node-based editor with clips corresponding to the text segments.

4. The method of claim 1, further comprising adding an environmental modifier node that adjusts at least one parameter selected from lighting, background, volumetric effects, or camera motion in real time.

5. The method of claim 1, wherein applying the generative transformation includes synchronizing a previously uploaded voice profile to a character's dialogue using a lip-sync model selected from Wav2Lip, LipGAN, or SyncNet.

6. A system for node-based video editing with integrated generative capabilities, comprising:
(a) a clip database configured to store a plurality of video and audio assets;
(b) a node-based editor module configured to represent each clip, generative effect, or modifier as a distinct node;
(c) a processing engine configured to analyze input files and map identified segments to respective nodes;
(d) a generative AI module operable to perform at least one of visual style transfer, character replacement, object replacement, environment adjustments, face-swapping, lip-syncing, or audio synthesis; and
(e) an export module configured to compile the edited sequence into an industry-standard video format.

7. The system of claim 6, further comprising a timeline view operably linked to the node-based editor, wherein modifications to node connections are automatically reflected in the timeline sequence.

8. The system of claim 6, wherein the generative AI module further comprises an AI-driven upscaling node selected from ESRGAN, Real-ESRGAN, or a similar model, configured to enhance image quality prior to final export.
